(19) United States
(12) Patent Application Publication
(10) Pub. No.: US 2017/0058948 A1
(43) Pub. Date: Mar. 2, 2017

(54) TAPERED ROLLER BEARING WITH REDUCED FRICTION

(71) Applicant: Schaeffler Technologies AG & Co. KG, Herzogenaurach (DE)

(72) Inventors: Jonathan Murray, Troy, MI (US); Majkol Spirovski, Macomb Township, MI (US)

(73) Assignee: Schaeffler Technologies AG & Co. KG, Herzogenaurach (DE)

(21) Appl. No.: 14/843,191

(22) Filed: Sep. 2, 2015

(51) Int. Cl. F16C 19/49

(52) U.S. Cl. CPC F16C 19/497

(57) ABSTRACT

A low friction tapered roller bearing is provided that implements either needle rollers, nested needle rollers, nested balls, or a thrust washer between the tapered rollers and the large rib of the inner ring. The nested needle rollers and balls options can either be cage guided or full complement.

### TECHNICAL FIELD

Example aspects described herein relate to bearing assemblies, particularly of tapered roller bearing assemblies that contain additional rolling elements to reduce friction in the axial or thrust direction.

### BACKGROUND

Bearing assemblies are typically circular in shape, and generally comprise of rolling elements, normally contained by a cage, disposed between inner and outer raceways. Rolling elements take many forms, including spherical balls, cylindrical rollers, needle rollers, or various other configurations, such as cone-shaped tapered rollers or barrel-shaped spherical rollers. Cages are often used to contain the rolling elements and guide them throughout the rotating motion of the bearing, but are not a necessity in some configurations. The material of a cage can vary from steel to plastic, depending on the application, duty cycle, along with noise and weight requirements.

The type of bearing used for a particular application depends on multiple factors including the magnitude of the load and the load direction. Angular contact ball bearings are able to withstand combined radial and axial loads. Tapered roller bearings are also able to withstand combined radial and axial loads, but, for a given bearing envelope size, have a higher load capacity than angular contact ball bearings. The design of tapered roller bearings is such that the inner and outer raceways are angled with respect to the central axis of the bearing. For a given width of envelope space, the angled raceway increases the amount of line contact between the roller and raceway which increases the load capacity of the bearing. The angled raceway also allows the tapered roller bearing to carry combinations of radial and thrust loads. Resultant loads on a tapered roller bearing generate a force that pushes the roller against the large rib of the inner raceway as shown in FIG. 7, which is a source of friction that this invention addresses.

### SUMMARY OF THE INVENTION

A new design for a tapered roller bearing is disclosed that reduces the inherent friction that occurs between the roller and the large rib of the inner raceway. In one example embodiment of the invention, needle rollers are placed between the large diameter end of the tapered roller and the corresponding large rib interface of the inner raceway in order to reduce the friction.

### BRIEF DESCRIPTION OF DRAWINGS

The above mentioned and other features and advantages of the embodiments described herein, and the manner of attaining them, will become apparent and be better understood by reference to the following descriptions of multiple example embodiments in conjunction with the accompanying drawings. A brief description of the drawings now follows.

FIG. 1 is a perspective view of a first example embodiment of a tapered roller bearing assembly with a needle roller placed between the large diameter end of the tapered roller and the large rib of the inner ring.

FIG. 2 is a perspective view of the inner ring of the tapered roller bearing assembly of FIG. 1.

FIG. 3 is a perspective view of the outer ring of the tapered roller bearing assembly of FIG. 1.

FIG. 4 is a sectioned view of the tapered roller bearing assembly of FIG. 1.

FIG. 5 is a sectioned view of a second example embodiment of a tapered roller bearing assembly with nested balls placed between the large diameter end of the tapered roller and the large rib of the inner ring.

FIG. 6 is a sectioned view of a third example embodiment of a tapered roller bearing assembly with a thrust washer placed between the large diameter end of the tapered roller and the large rib of the inner ring.

FIG. 7 is a sectioned view of a prior art tapered roller bearing assembly.

### DETAILED DESCRIPTION OF THE INVENTION

Identically labeled elements appearing in different figures refer to the same elements but may not be referenced in the description for all figures. The exemplification set out herein illustrates embodiments which should not be construed as limiting the scope of the claims in any manner. A radially inward direction is from an outer radial surface of the outer raceway, toward the central axis or radial center of the outer raceway. Conversely, a radial outward direction indicates the direction from the central axis or radial center of the outer raceway toward the outer surface. Axially refers to directions along a diametric central axis.

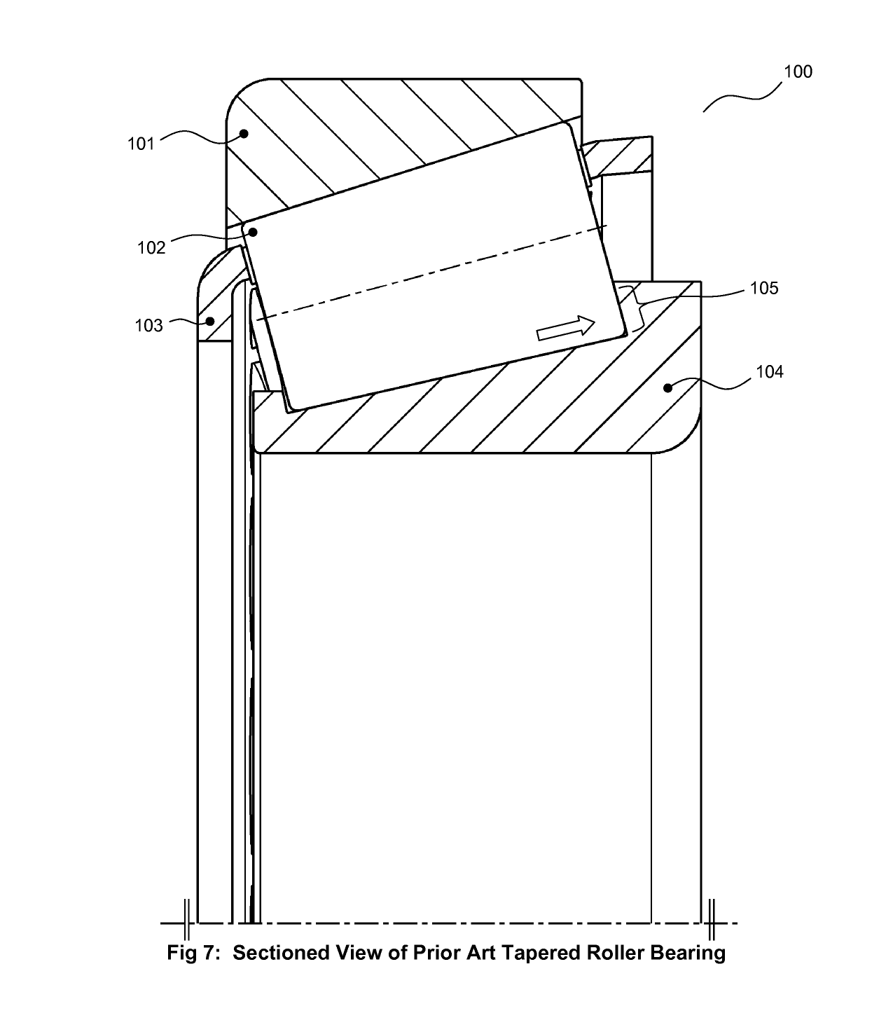

FIG. 7 is a sectioned view of a prior art tapered roller bearing assembly 100. The bearing assembly comprises of the outer ring 101, tapered rollers 102, cage 103, and inner ring 104. The inner ring 104 contains a large rib 105 for contact with the tapered rollers. Contact at this interface and the subsequent resultant sliding friction occurs in most tapered roller bearings.

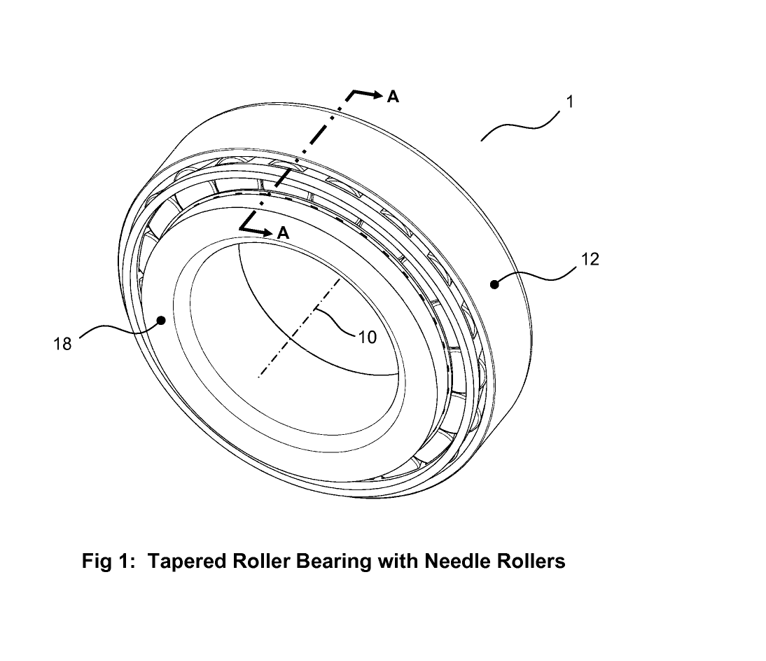

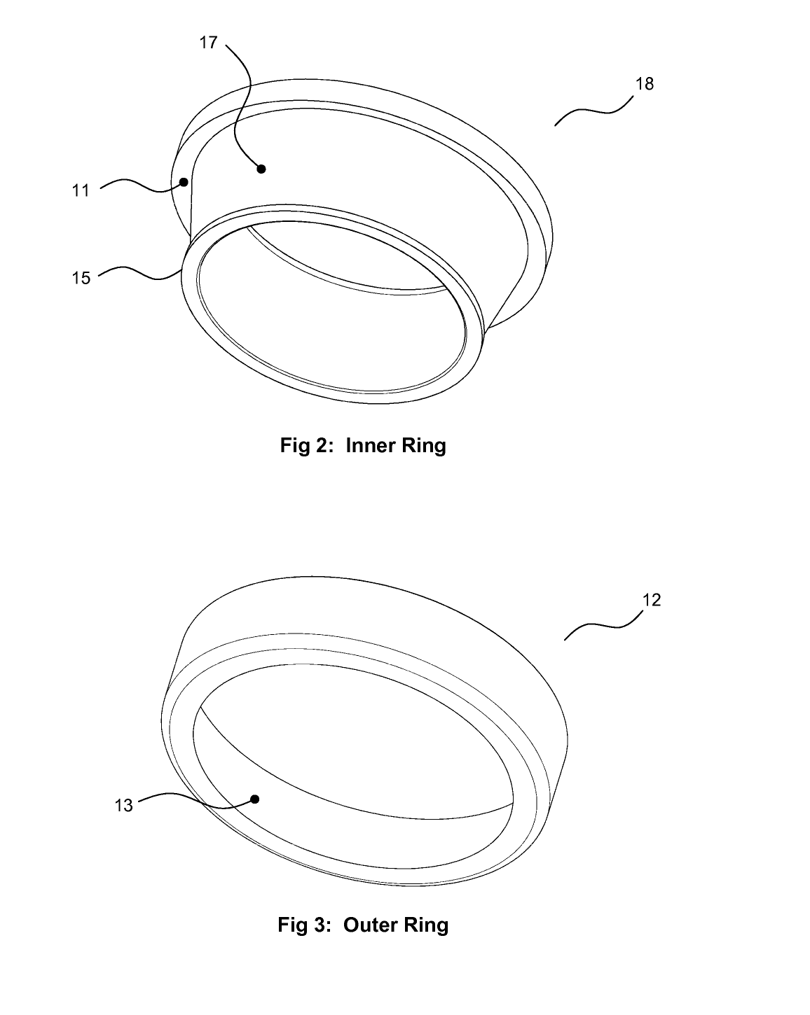

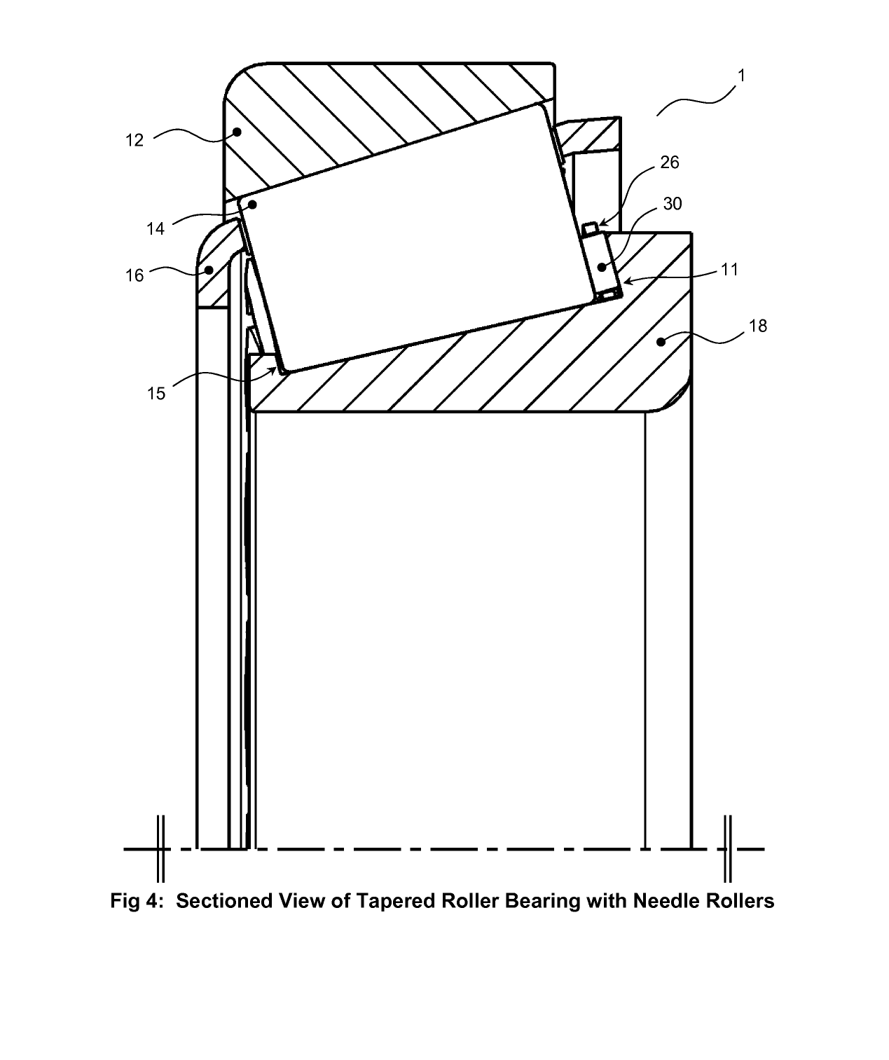

FIG. 1 is a perspective view of a tapered roller bearing assembly according to a first example embodiment. FIGS. 2 and 3 are perspective views of the respective inner and outer rings of the bearing of FIG. 1. FIG. 4 is a sectioned view of the bearing of FIG. 1. The following description should be viewed in light of FIGS. 1-4. The bearing assembly 1 consists of an outer ring 12, tapered rollers 14, tapered roller cage 16, inner ring 18, needle rollers 30 and needle roller cage 26. Outer ring 12 contains an angled outer raceway 13 which is a direct interface for the tapered rollers. Inner ring 18 contains an angled raceway 17 that is recessed within the inner ring such that a small rib 15 and large rib 11 are formed at the ends of the raceway. The thrust surfaces of the small rib and large rib are approximately perpendicular to the angled raceway 17. Angled raceway 17 is a direct interface for the tapered rollers. Needle rollers 30 and needle roller cage 26 are located between the end of the tapered rollers and the large rib of the inner ring. Under application loads as the tapered rollers orbit around central axis 10, the tapered rollers are pushed against the needle rollers to facilitate a rolling interface as opposed to a sliding interface between the tapered roller end and the large rib that occurs in the prior art bearing. Therefore, a lower friction condition exists with the presence of a needle roller placed between the tapered roller and the large rib of the inner ring.

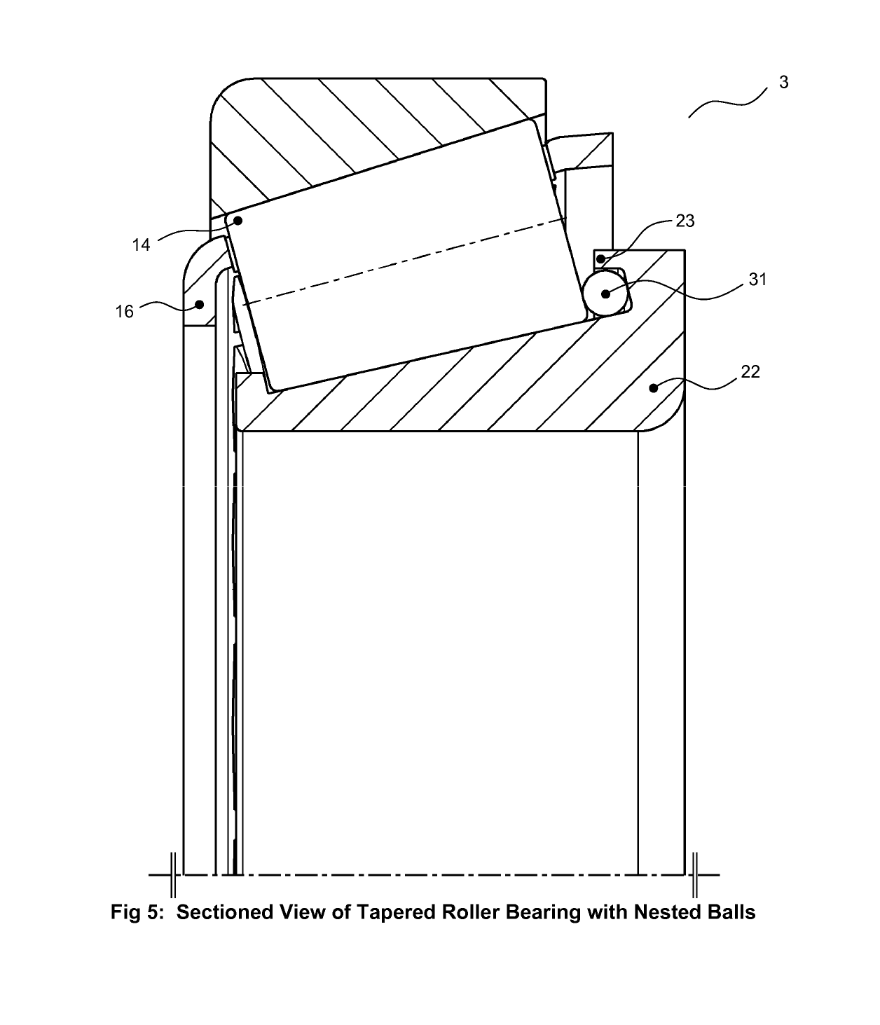

FIG. 5 is a sectioned view of a tapered roller bearing assembly according to a second example embodiment. This embodiment utilizes balls 31 placed between the tapered rollers 14 and large rib 11, however, the inner ring 22 contains a flange 23 on the large rib that extends axially such that the balls are captured, and, as shown, a cage can be optionally omitted resulting in a full complement configuration. Rolling elements other than balls can also be used in this embodiment.

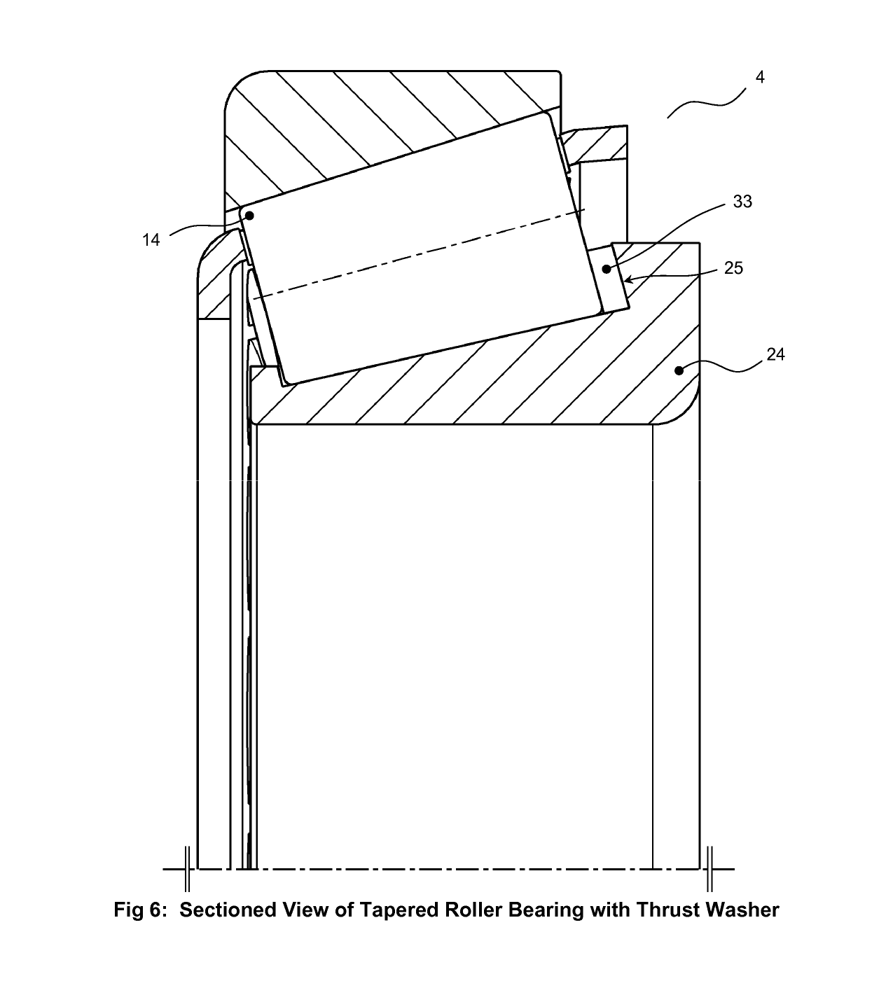

FIG. 6 is a sectioned view of a tapered roller bearing assembly according to a third example embodiment, in which a thrust washer 33 is utilized between the ends of the tapered rollers 14 and the large rib 25 of the inner ring 24. The use of a thrust washer eliminates the need for expensive finish machining operations, such as grinding and honing, that are typically applied to the large rib of the inner ring to ensure a robust thrust interface for the tapered roller. Therefore, the application of a thrust washer, with the appropriate hardness and surface characteristics, provides a means of reducing the cost of the tapered roller bearing.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying figures.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

### LIST OF REFERENCE SYMBOLS

1 Tapered Roller Bearing Assembly, Needle Roller Design

3 Tapered Roller Bearing Assembly, Nested Ball Design

4 Tapered Roller Bearing Assembly, Thrust Washer Design

10 Central Axis, Needle Roller Design

11 Large Rib, Needle Roller Design

12 Outer Ring, Needle Roller Design

13 Outer Raceway, Needle Roller Design

14 Tapered Rollers

15 Small Rib, Needle Roller Design

16 Cage, Tapered Roller

17 Inner Raceway, Needle Roller Design

18 Inner Ring, Needle Roller Design

22 Inner Ring, Nested Ball Design

23 Flange on Large Rib, Nested Ball Design

24 Inner Ring, Thrust Washer Design

26 Cage, Needle Roller Design

30 Needle Rollers

31 Balls

33 Thrust Washer

100 Prior Art Tapered Roller Bearing Assembly

101 Outer Ring

102 Tapered Roller

103 Cage

104 Inner Ring

105 Thrust Contact Surface

What we claim is:

1. A tapered roller bearing comprising:
an outer ring; having:
an angled raceway having a first small diameter end and a second large diameter end; and,
a radial outer surface;
an inner ring; having:
a recessed angled raceway having a first small diameter end and a second large diameter end, a small rib projecting substantially perpendicular to the raceway on the first small diameter end and a large rib projecting substantially perpendicular to the raceway on the second large diameter end; and,
an inner radial surface;
a plurality of tapered rollers having a frustoconical outer surface with a first small diameter end and a second large diameter end, arranged between the angled raceway of the outer ring and the angled raceway of the inner ring, wherein the small diameter end of the rollers is within the space defined by the first small diameter end of the angled raceway of the outer ring and the first small diameter end of the angled raceway of the inner ring;
a first cage disposed between the angled raceway of the inner ring and the angled raceway of the outer ring, having pockets in which the tapered rollers are received;
a plurality of needle rollers arranged within the space defined by the second large diameter end of the tapered rollers and the large rib of the inner ring; and,
a second cage disposed between the space defined by the second large diameter end of the tapered rollers and the large rib of the inner ring, having pockets in which the plurality of needle rollers is received.

2. The assembly of claim 1, wherein the plurality of needle rollers and the second cage is replaced by a thrust washer.

3. The assembly of claim 2, wherein the thrust washer is metal.

4. A tapered roller bearing comprising:
an outer ring, having:
an angled raceway having a first small diameter end and a second large diameter end; and,
a radial outer surface;
an inner ring; having:
a recessed angled raceway having a first small diameter end and a second large diameter end, wherein a small rib projecting substantially perpendicular to the raceway is on the first small diameter end and a large rib projecting substantially perpendicular to the raceway is on the second large diameter end, wherein the end of the large rib contains an axially projecting flange defining a pocket; and
an inner radial surface;
a plurality of tapered rollers having a frustoconical outer surface with a first small diameter end and a second large diameter end, arranged between the angled raceway of the outer ring and the angled raceway of the inner ring, wherein the small diameter end of the rollers is within the space defined by the first small diameter end of the angled raceway of the outer ring and the first small diameter end of the angled raceway of the inner ring; and
a plurality of rolling elements arranged within the space defined by the second large diameter end of the tapered rollers and the pocket of the inner ring.

5. The assembly of claim 3, wherein the plurality of rolling elements consists of needle rollers.

6. The assembly of claim 3, wherein the plurality of rolling elements consists of balls.

7. The assembly of claim 3, wherein a second cage with pockets to receive the plurality of rolling elements is disposed within the space defined by the second large diameter end of the tapered rollers and the pocket of the inner ring.

8. The assembly of claim 7, wherein the plurality of rolling elements consists of needle rollers.

9. The assembly of claim 7, wherein the plurality of rolling elements consists of balls.
